(19) United States
(12) Patent Application Publication
(10) Pub. No.: US 2018/0173940 A1
(43) Pub. Date: Jun. 21, 2018

(54) SYSTEM AND METHOD FOR MATCHING AN OBJECT IN CAPTURED IMAGES

(71) Applicant: CANON KABUSHIKI KAISHA, Tokyo (JP)

(72) Inventors: Getian Ye, Kogarah (AU); Fei MAI, Marsfield (AU); Geoffrey Richard Taylor, Carlingford (AU)

(21) Appl. No.: 15/384,154

(22) Filed: Dec. 19, 2016

(51) Int. Cl. G06K 9/00; G06K 9/52

(52) U.S. Cl. CPC G06K 9/00288; G06K 9/52; G06K 2009/4666; G06K 9/00771; G06K 9/00268

(57) ABSTRACT

A method of matching a person in captured images comprises determining first feature vectors from a first image sequence of person(s), and determining second feature vectors from a second image sequence of person(s). The first and second feature vectors are determined based on properties of pixels located in the first and second image sequences respectively. The method further comprises, for a first feature vector corresponding to a first person in the first image sequence, determining a reference distance to one of the second feature vectors corresponding to a reference person in the second image sequence; determining a distance metric by constraining a distance between the first feature vector and a feature vector corresponding to the first person in the second image sequence, according to the determined reference distance; and matching a pair of images of the person in the captured images based on the distance metric.

### TECHNICAL FIELD

This application relates generally to image processing and, in particular, to matching objects between two captured images to determine whether a candidate object is an object of interest. In one example, the terms “candidate object” and “object of interest” respectively refer to (i) a person in a crowded airport, the person being merely one of the crowd, and (ii) a person in that crowd that has been identified as being of particular interest. This application also relates to a computer program product including a computer readable medium having recorded thereon a computer program for matching objects between two captured images to determine whether a candidate object is an object of interest.

### BACKGROUND

Public venues such as shopping centres, parking lots and train stations are increasingly subjected to surveillance with large-scale networks of video cameras. Application domains of large-scale video surveillance include security, safety, traffic management and business analytics. One of the key tasks in the application of large-scale video surveillance is person re-identification, that is to match persons captured by different cameras at different time and locations. Person re-identification is often required to match persons in different viewpoints and different lighting conditions as cameras at different locations often have different view angles and work under different environments with different lighting conditions. The visual appearance of a person may change significantly between different camera views if a large difference occurs in camera view angles and lighting conditions. In addition, occlusions often occur in a crowded public place such as shopping centre and train station and are caused by other people in the scene or static objects such as walls or pillars. Occlusions often result in an incomplete visual appearance of a person. Matching a person from different camera views and different lighting conditions in a crowded environment is difficult.

A person re-identification process is typically comprised of two major steps: feature extraction and distance calculation. The feature extraction step often extracts low-level image features such as colour, texture, and special structure from a person's image and form an appearance descriptor for the person by combining the extracted low-level image features. Given a person's image in a camera view, the matching step finds the closest match to the given image from a set of images in another camera view based on the distances from the given image to each image in the image set. The image with the smallest distance to the given image is considered to be the closet match to the given image. A distance metric must be selected to measure the distance between appearance descriptors of two images. Selecting a good distance metric is crucial for the matching performance of person re-identification. General-purpose distance metrics, e.g., Euclidean distance, cosine distance, and Manhattan distance, often fail to capture the characteristics of appearance descriptors and hence the performance of general purpose distance metrics is usually limited. To avoid the limitation of the general-purpose distance metrics, distance metric learning learns a distance metric from a given training dataset containing several training samples. Each training sample often contains a pair of appearance descriptors and a classification label indicating if the two appearance descriptors are created from images belonging to the same person or different persons. The classification label is defined as +1 if the appearance descriptors belonging to the same person while the classification label is defined as −1 if the appearance descriptors belonging to different persons. The training samples with positive and negative classification labels are called positive and negative training samples, respectively. The distance metric is explicitly learned to minimize a distance between the appearance descriptors in each positive training sample and maximize the distance between the appearance descriptors in each negative training sample. Most distance metric learning methods learn the Mahalanobis distance metric parametrized by a positive semi-definite matrix.

One distance metric learning method for person re-identification uses an information theoretic approach to regularise the estimated parameter matrix of the Mahalanobis distance metric by minimising the distance from the estimated parameter matrix to a predefined matrix, e.g., an identity matrix. The parameter matrix is estimated so that the Mahalanobis distance between the appearance descriptors in each positive training sample is less than a predefined threshold and the Mahalanobis distance between the appearance descriptors in each negative training sample is larger than another predefined threshold while being maintained as close as possible to the predefined matrix. The parameter matrix is iteratively estimated by performing a cyclic projection for training samples until convergence.

Another distance metric learning method for person re-identification learns a Mahalanobis distance metric using discriminative linear logistic regression. The parameter matrix is estimated by finding a bound so that all the distances between appearance descriptors of positive training samples are smaller than all the distances between appearance descriptors of negative training samples based on the bound. The parameter matrix is iteratively estimated using a gradient ascent algorithm.

The distance metric learning methods described above restrict the distance between the appearance descriptors in each positive training sample to be smaller than a fixed threshold, and restrict the distance between the appearance descriptors in each negative training sample to be larger than another fixed threshold. The fixed thresholds may limit the effectiveness of the distance metric learning, especially when the variations in visual appearances are complex due to different camera views and different lighting conditions.

Another distance metric learning method for person re-identification formulates distance metric learning based on a statistical inference perspective. The optimal statistical decision determines whether the two appearance descriptors of a training sample belong to the same person or not can be determined by a likelihood ratio test. By assuming the differences between appearance descriptors to be multivariate Gaussian distribution, the parameter matrix of the Mahalanobis distance is estimated based on two covariance matrices. One covariance matrix is the sum of the covariance of the difference between appearance descriptors of each positive training sample. The other covariance matrix is the sum of the covariance of the difference between appearance descriptors of each negative training sample.

Another distance metric learning method exploits the depth feature in RGB-D images for person re-identification. The depth features in RGB-D images are treated as privileged information to improve the learning of the Mahalanobis distance metric for RGB images as depth features are robust against to changes in lighting conditions. However, the method requires all the training images to be RGB-D images and requires the depth channel to be geometrically aligned with the RGB channels in each RGB-D image. The parameter matrix is estimated so that the Mahalanobis distance between the appearance descriptors in each positive training sample is less than the Mahalanobis distance between the depth features and the Mahalanobis distance between the appearance descriptors in negative training sample is larger than the Mahalanobis distance between the depth features. The parameter matrix is iteratively estimated by performing a cyclic projection for training samples until convergence.

A need exists to exploit privileged information extracted from the visual appearance of objects to improve the distance metric learning for person or object matching.

### SUMMARY

It is an object of the present invention to substantially overcome, or at least ameliorate, one or more disadvantages of existing arrangements.

One aspect of the present disclosure provides a method of matching a person in a plurality of captured images, the method comprising: determining a plurality of first feature vectors from a first image sequence of one or more persons, the first feature vectors being determined based on pixel properties of pixels located in the first image sequence; determining a plurality of second feature vectors from a second image sequence of one or more persons, the second feature vectors being determined based on pixel properties of pixels located in the second image sequences; for one of the first feature vectors corresponding to a first person in the first image sequence, determining a reference distance to one of the second feature vectors corresponding to a reference person in the second image sequence; determining a distance metric by constraining a distance between the first feature vector corresponding to the first person in the first image sequence and a feature vector corresponding to the first person in the second image sequence, according to the determined reference distance; and matching at least one pair of images of the person in the plurality of captured images based on a distance determined using the distance metric.

In some aspects, the reference person is the first person.

In some aspects, the reference person is a different person to the first person.

In some aspects, determining the reference distance comprises determining distances between the first person and each of the plurality of second vector features and determining a classification of a label associated with the first person and the reference person.

In some aspects, the label is a positive label and the reference distance relates to a minimum of the determined distances.

In some aspects, the label is a negative label and the reference distance relates to a maximum of the determined distances.

In some aspects, the reference distance between the first person and the reference person is determined based on a reference distance metric.

In some aspects, the reference distance is determined in relation to a reliable region of the first person and a reliable region of the reference person.

In some aspects, determining the distance metric comprises determining a difference between an inverse of the reference distance and the inverse of the distance between the first feature vector corresponding to the first person in the first image sequence and the feature vector corresponding to the first person in the second image sequence.

In some aspects, constraining the distance between the first feature vector corresponding to the first person in the first image sequence and the feature vector corresponding to the first person in the second image sequence comprises determining a step size between the reference distance and the distance between first feature vector corresponding to the first person in the first image sequence and the feature vector corresponding to the first person in the second image sequence.

In some aspects, the plurality of captured images comprise a query image and a gallery image, and the method further comprises: determining feature vectors for a person in the query image and for a person in the gallery image; and matching the at least one pair of images comprises determining a distance between the person in the query image and the person in the gallery image using the distance metric.

In some aspects, the first image sequence and the second image sequence form part of a training set of images.

In some aspects, the distance metric is determined on a server computer and the at least one pair of images of the person in the plurality of captured images is matched on a user computer in communication with the server computer.

In some aspects, determining the reference distance comprises determining reference distances between the first person and each of the plurality of second vector features and selecting one of the reference distances.

Another aspect of the present disclosure provides a computer readable medium having a program stored thereon for matching a person in a plurality of captured images, the program comprising: code for determining a plurality of first feature vectors from a first image sequence of one or more persons, the first feature vectors being determined based on pixel properties of pixels located in the first image sequence; code for determining a plurality of second feature vectors from a second image sequence of one or more persons, the second feature vectors being determined based on pixel properties of pixels located in the second image sequences; code for, for one of the first feature vectors corresponding to a first person in the first image sequence, determining a reference distance to one of the second feature vectors corresponding to a reference person in the second image sequence; code for determining a distance metric by constraining a distance between the first feature vector corresponding to the first person in the first image sequence and a feature vector corresponding to the first person in the second image sequence, according to the determined reference distance; and code for matching at least one pair of images of the person in the plurality of captured images.

Another aspect of the present disclosure provides apparatus for matching a person in a plurality of captured images, the apparatus comprising: means for determining a plurality of first feature vectors from a first image sequence of one or more persons, the first feature vectors being determined based on pixel properties of pixels located in the first image sequence; means for determining a plurality of second feature vectors from a second image sequence of one or more persons, the second feature vectors being determined based on pixel properties of pixels located in the second image sequences; for one of the first feature vectors corresponding to a first person in the first image sequence, means for determining a reference distance to one of the second feature vectors corresponding to a reference person in the second image sequence; means for determining a distance metric by constraining a distance between the first feature vector corresponding to the first person in the first image sequence and a feature vector corresponding to the first person in the second image sequence, according to the determined reference distance; and means for matching at least one pair of images of the person in the plurality of captured images based on a distance determined using the distance metric.

Another aspect of the present disclosure provides a system, comprising: a server computer; a communications network and a user device in communication with server computer via the communications network; wherein the server computer comprises: a memory for storing data and a computer readable medium; and a processor coupled to the memory for executing a computer program, the program having instructions for: determining a plurality of first feature vectors from a first image sequence of one or more persons, the first feature vectors being determined based on pixel properties of pixels located in the first image sequence; determining a plurality of second feature vectors from a second image sequence of one or more persons, the second feature vectors being determined based on pixel properties of pixels located in the second image sequences; for one of the first feature vectors corresponding to a first person in the first image sequence, determining a reference distance to one of the second feature vectors corresponding to a reference person in the second image sequence; determining a distance metric by constraining a distance between the first feature vector corresponding to the first person in the first image sequence and a feature vector corresponding to the first person in the second image sequence, according to the determined reference distance; and transmitting the distance metric to the user device via the network; and the user device is configured to receive the distance metric via the communications network and execute a program to match at least one pair of images of a person in a plurality of captured images based on a distance determined using the distance metric.

Other aspects of the invention are also disclosed.

### BRIEF DESCRIPTION OF THE DRAWINGS

One or more example embodiments of the invention will now be described with reference to the following drawings, in which:

FIG. 1A is a schematic diagram illustrating a top-down view of a surveillance camera network monitoring a city area;

FIGS. 1B(1)-(3) are schematic diagrams illustrating fields of view of two cameras monitoring the city area shown in FIG. 1A;

FIGS. 2A and 2B form a schematic block diagram of a general purpose computer system, upon which described methods may be practiced;

FIG. 3 is a schematic flow diagram showing a method of matching objects between images using a learned distance;

FIG. 4 is a schematic flow diagram showing a method of determining an appearance descriptor of an object as used in the method of FIG. 3;

FIG. 5 is a schematic flow diagram showing a method of matching a query object to gallery objects as used in the method of FIG. 3;

FIG. 6 is a schematic flow diagram showing a method of creating a training dataset and determining privileged information at a customer site;

FIG. 7 is a schematic flow diagram showing a method of determining privileged information from training samples and the corresponding training images as used in the method of FIG. 6;

FIG. 8 is a schematic flow diagram showing a method of determining privileged information for a training sample using reference distances as used in the method of FIG. 7;

FIG. 9 is a schematic flow diagram showing another method of determining privileged information for a training sample using reference distances as used in the method of FIG. 7; and

FIG. 10 is a schematic flow diagram showing a method of learning a distance metric using training dataset and privileged information as used in the method of FIG. 3.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and the section above relating to prior art arrangements relate to discussions of documents or devices which may form public knowledge through their respective publication and/or use. Such discussions should not be interpreted as a representation by the present inventors or the patent applicant that such documents or devices in any way form part of the common general knowledge in the art.

During the process of learning a distance metric for person re-identification, some privileged information is often available in the visual appearance feature space and may be used to help the distance metric learning to learn an improved distance metric. For example, the distance measured by a general-purpose distance metric may indicate whether or not a training sample is a hard training sample based on the distance and classification label. Moreover, the distance between appearance descriptors extracted from reliable image regions, e.g., regions without occlusions, may provide guidance for the distance metric learning. The above-mentioned methods of distance method learning either ignore the privileged information or rely on the privileged information extracted from a different sensor modality. Extracting privileged information from a different sensor modality increases the complexity of training process due to the requirements for an extra sensor modality and an accurate image alignment method for aligning images in different modalities.

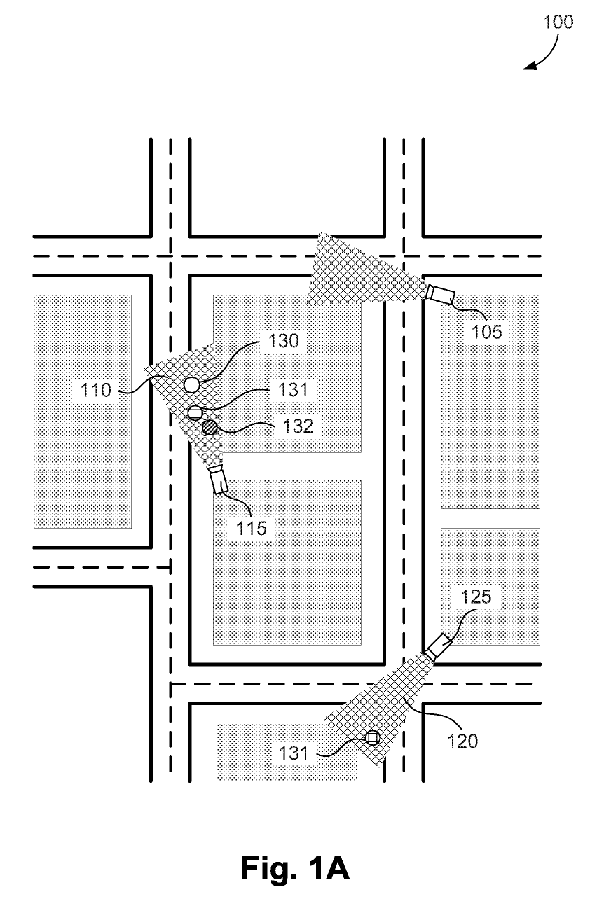

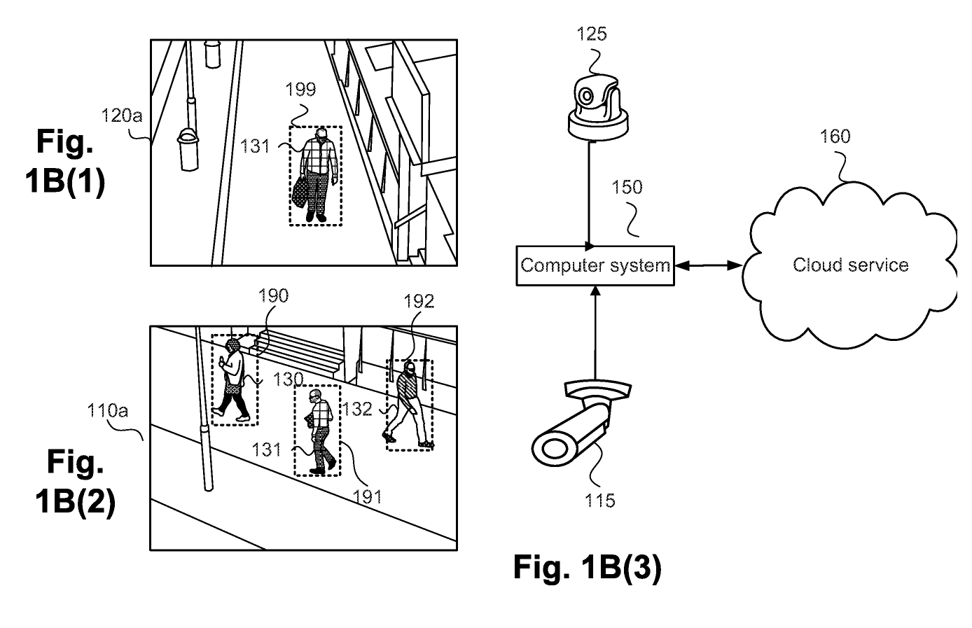

The present disclosure provides a method, system and apparatus for matching an object between two camera views at different time and locations using a locally constrained distance metric learning technique, referred to as “LCML” throughout this disclosure. FIG. 1A is a simplified diagram showing a top-down view of an exemplary use case to which LCML arrangements may be applied. In the example of FIG. 1A, a city area 100 is monitored by a network of cameras 105, 115, 125. A field of view (FOV) 110 of the camera 115 captures a first scene with three moving targets 130, 131, 132 at a time instant. A field of view 120 of the camera 125 captures a second scene with one moving target 131 at another time instant. The camera 125 and the camera 115 have no overlapping FOV. The cameras 115 and 125 capture a common target 131, albeit at different times. The arrangements described relate to matching the moving targets across cameras, for example, re-identifying the target 131 across cameras 115 and 125. The target objects 130, 131 and 132 are people in the example of FIG. 1A. However, the arrangements described can be equally applied to target objects other than people.

The fields of view 110 and 120 of the cameras 115 and 125 respectively are further illustrated in FIGS. 1B(2) and 1B(1). In the example of FIGS. 1B(1) and 1B(2), a goal is to determine whether a person of interest 131 with a detected bounding box 199 in an image 120a captured by the camera 125, is present in an image 110a captured by the camera 115. The cameras 115 and 125 are connected to a computer system 150 to which arrangements described may be applied, as shown in FIG. 1B(C). The computer system 150 is connected to a cloud server 160 via the Internet, to which arrangements described may be applied. In the example of FIG. 1B(2), the second image 110a contains three people 130, 131 and 132, with detected bounding boxes 190, 191 and 192, that may be the person of interest 131 detected as 199 from the image 120a. The arrangements described are applied to determine which of the three detections 190, 191 and 192 is a best match for the detected object of interest bounded by 199. The arrangements described may equally be applied when images of the object of interest and candidate objects are captured by different cameras simultaneously or at different times, or captured by the same camera at different times, including images that represent the same scene or different scenes, or multiple scenes with different candidate objects.

The cameras 105, 115 and 125 may be any type of image capture device suitable for capturing an image of a scene using a sensor such as an optical sensor, an infrared sensor, a radar sensor, and the like or be multi-sensor devices. The images used for determining a distance metric and for matching persons or objects are captured by the same type of sensor. The cameras 105, 115 and 125 may be a digital camera, for example.

An object of interest, such as the person detected at the bounding box 199 in FIG. 1B(1), is an object that has been identified as being of particular interest. An “object of interest” may also be referred to as a “query object”. A candidate object, such as the detected persons of the bounding boxes 190, 191 or 192, is an object that is to be tested to determine whether the person has the same identity with the object of interest. The term “candidate object” may also be referred to as a “gallery object”. In one example, an object of interest is a person who has been identified as being suspicious at an airport. A candidate object is a person in a crowded airport, the person being merely one of the crowd.

A captured image, such as the image 110a, is made up of visual elements. The terms “pixel”, “pixel location” and “image location” are used throughout the present application to refer to one of the visual elements in a captured image. Each pixel of an image is described by one or more values characterising a property of the scene captured in the image. In one example, a single intensity value characterises the brightness of the scene at the pixel location. In another example, a triplet of values characterise the colour of the scene at the pixel location. Furthermore, a “region”, “image region” or “cell” in an image refers to a collection of one or more spatially adjacent visual elements.

A “feature” represents a derived value or set of derived values determined from the pixel values in an image region. The term “feature” may also be referred to as a “descriptor”. In one example, a feature is a histogram of colour values in the image region. In another example, a feature is an “edge” response value determined by estimating an intensity gradient in the region. In yet another example, a feature is a filter response, such as a Gabor filter response, determined by the convolution of pixel values in the region with a filter kernel. Furthermore, a “feature map” assigns a feature value to each pixel in an image region. In one example, a feature map assigns an intensity value to each pixel in an image region. In another example, a feature map assigns a hue value to each pixel in an image region. In yet another example, a feature map assigns a Gabor filter response to each pixel in an image region. Finally, a “feature distribution” refers to the relative frequency of feature values in a feature map, normalized by the total number of feature values. In one arrangement, a feature distribution is a normalized histogram of feature values in a feature map. In another LCML arrangement, a feature distribution is estimated using Kernel Density Estimation (KDE) based on the feature values in the feature map. In yet another example, a feature distribution is estimated as a Gaussian Mixture Model (GMM) based on the pixel values in the feature map.

As illustrated in FIG. 1B(3), the cameras 115 and 125 communicate with a computer system 150. The cameras 115 and 125 may be any type of image capture device suitable for capturing digital images, for example a s digital camera or a video camera. The cameras 115 and 125 may be in wired or wireless communication with the computer system 150. The example of FIG. 1B can be applied to a range of applications. In one example, the computer system 150 allows a security guard to select an object of interest through an interactive user interface, and returns images of one or more candidate objects determined to be the object of interest. In another example, the computer system automatically selects an object of interest and matches the object across multiple distributed cameras in order to analyse the long-term behaviour of the object. In other arrangement, the computer system 150 is integral to one of the cameras 115 and 125.

While the example in the following description generally relate to surveillance tasks of monitoring persons, the method in the present disclosure may equally be practised on other types of objects. In one example, the method is applied to match cars and persistently track a suspicious car. A person skilled in the art will also recognize that the arrangements described may be applied to different types of sensors including near IR cameras, radar sensors, and laser scanners.

The arrangements describe differ from existing methods by using the distance between appearance descriptors. The arrangements described use privileged information extracted from the visual appearance space to improve the distance metric learning for matching objects such as people. The distance between appearance descriptors can provide guidance for the distance metric learning. The existing methods of distance method learning described above either ignore the privileged information or rely on the privileged information extracted from a different sensor modality. Extracting privileged information from a different sensor modality increases the complexity of training process due to the requirements for an extra sensor modality and an accurate image alignment method for aligning images in different modalities.

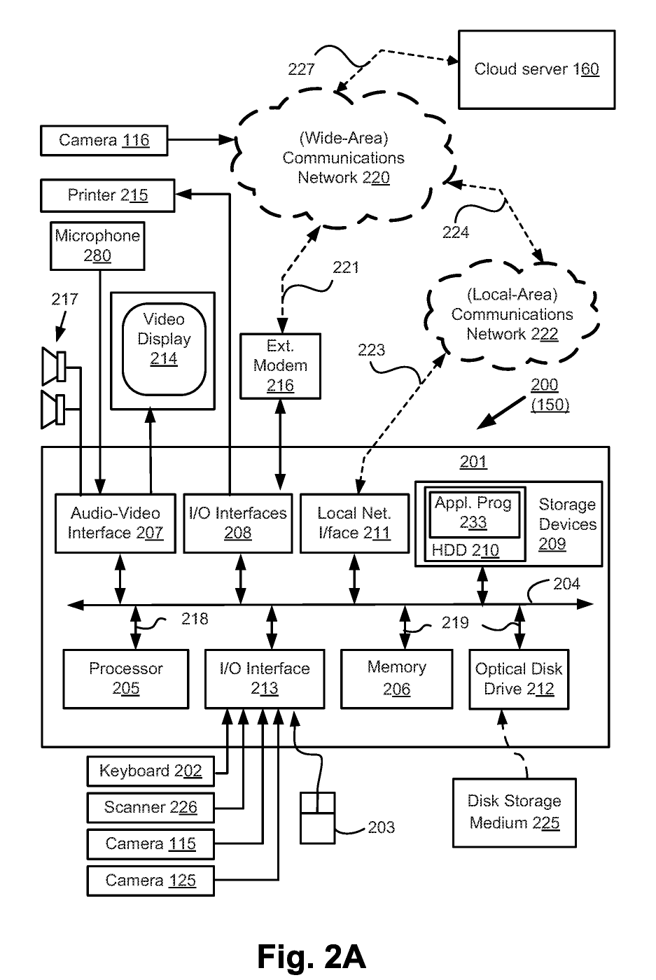

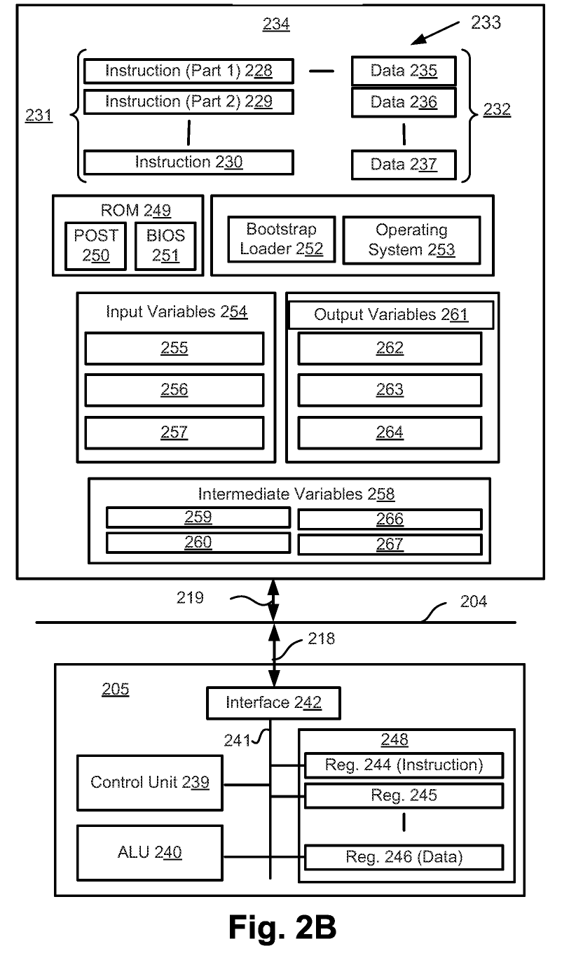

FIGS. 2A and 2B depict a general-purpose computer system 200, upon which the arrangements described can be practiced. The computer system 200 relates to the computer system 150.

As seen in FIG. 2A, the computer system 200 includes: a computer module 201; input devices such as a keyboard 202, a mouse pointer device 203, a scanner 226, one or more cameras such as the cameras 115 and 125, and a microphone 280; and output devices including a printer 215, a display device 214 and loudspeakers 217. An external Modulator-Demodulator (Modem) transceiver device 216 can be used by the computer module 201 for communicating to and from remote cameras such as a camera 116 over a communications network 220 via a connection 221. The camera 116 is an image capture device using a similar image capture sensor to the cameras 105, 115 and 125. The communications network 220 may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 220. The communication network 220 is connected to the cloud server 160 via a connection 227. In one arrangement, a cloud server 160 has the similar architecture to the computer module 201.

The computer module 201 typically includes at least one processor unit 205, and a memory unit 206. For example, the memory unit 206 may have semiconductor random access memory (RAM) and semiconductor read only memory (ROM). The computer module 201 also includes an number of input/output (I/O) interfaces including: an audio-video interface 207 that couples to the video display 214, loudspeakers 217 and microphone 280; an I/O interface 213 that couples to the keyboard 202, mouse 203, scanner 226, cameras 115 and 125 and optionally a joystick or other human interface device (not illustrated); and an interface 208 for the external modem 216 and the printer 215. In some implementations, the modem 216 may be incorporated within the computer module 201, for example within the interface 208. The computer module 201 also has a local network interface 211, which permits coupling of the computer system 200 via a connection 223 to a local-area communications network 222, known as a Local Area Network (LAN). As illustrated in FIG. 2A, the local communications network 222 may also couple to the wide network 220 via a connection 224, which would typically include a so-called “firewall” device or device of similar functionality. The local network interface 211 may comprise an Ethernet circuit card, a Bluetooth® wireless arrangement or an IEEE 802.11 wireless arrangement; however, numerous other types of interfaces may be practiced for the interface 211.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 200.

The components 205 to 213 of the computer module 201 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun Sparcstations, Apple Mac™ or alike computer systems.

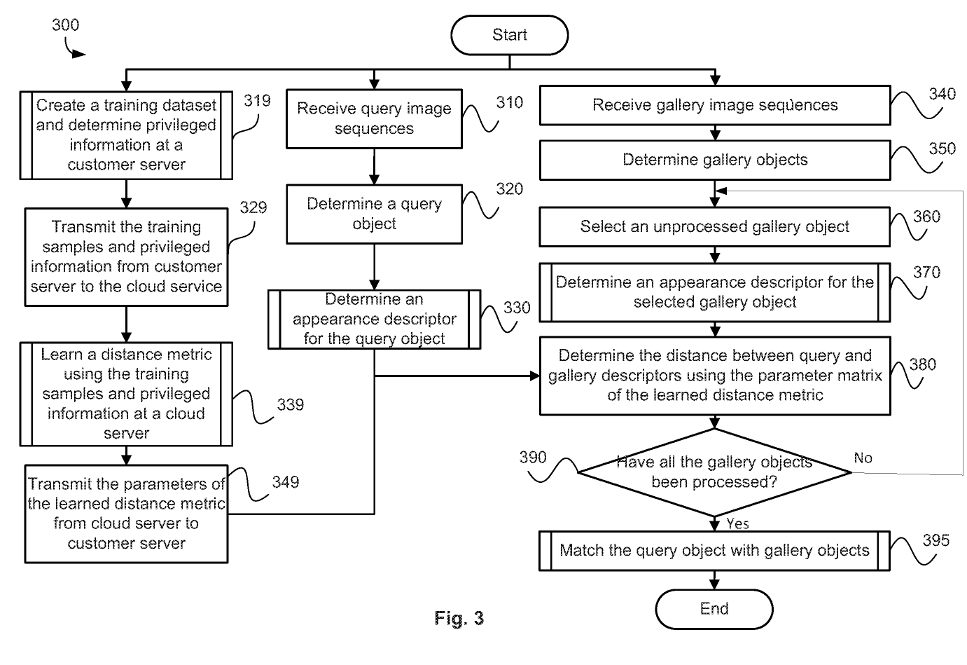

The methods described may be implemented using the computer system 200 wherein the processes of FIGS. 3, 4, 5, 7, 8 and 9, to be described, may be implemented as one or more LCML software application programs 233 executable within the computer system 200. In particular, the steps of the methods described are affected by instructions 231 (see FIG. 2B) in the software 233 that are carried out within the computer system 200. The software instructions 231 may be formed as one or more code modules, each for performing one or more particular tasks. The software may also be divided into two separate parts, in which a first part and the corresponding code modules performs the arrangements described and a second part and the corresponding code modules manage a user interface between the first part and the user.

The software 233 may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus or means for implementing the methods described.

The software 233 is typically stored in the HDD 210 or the memory 206. The software is loaded into the computer system 200 from a computer readable medium, and executed by the computer system 200. Thus, for example, the software 233 may be stored on an optically readable disk storage medium (e.g., CD-ROM) 225 that is read by the optical disk drive 212. A computer readable medium having such software or computer program recorded on it is a computer program product. The use of the computer program product in the computer system 200 preferably effects an apparatus for practicing the arrangements described.

In some instances, the application programs 233 may be supplied to the user encoded on one or more CD-ROMs 225 and read via the corresponding drive 212, or alternatively may be read by the user from the networks 220 or 222. Still further, the software 233 can also be loaded into the computer system 200 from other computer readable media. Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-Ray™ Disc, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of software, application programs, instructions and/or data to the computer module 201 include radio or infra-red transmission channels as well as a network connection to another computer or networked device, and the Internet or Intranets including e-mail transmissions and information recorded on Websites and the like.

The second part of the application programs 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

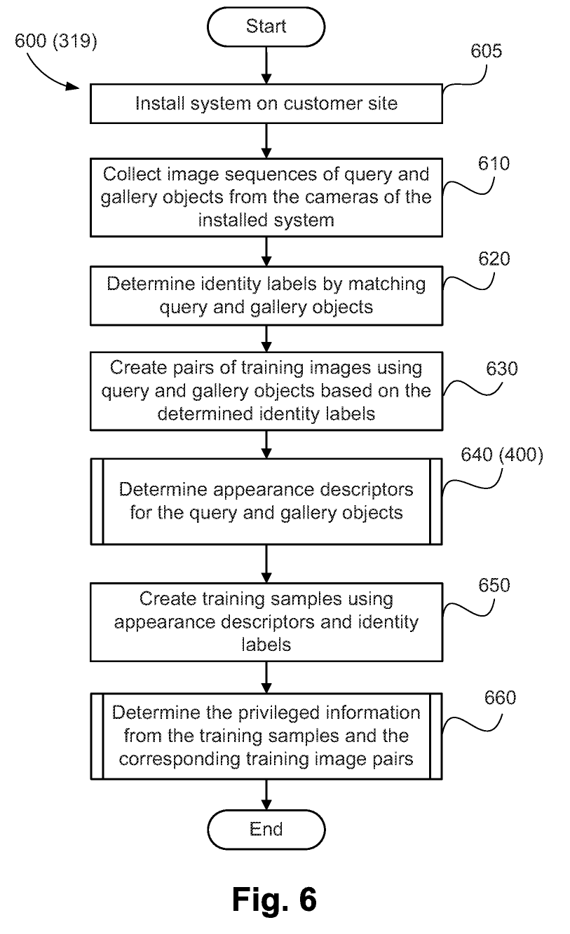

The arrangements described may be implemented using the cloud server 160 wherein the processes of FIGS. 6, 7, 8, 9, 10, to be described, may be implemented as one or more software application programs stored and executable within the cloud server 160.

FIG. 2B is a detailed schematic block diagram of the processor 205 and a “memory” 234 in the computer module 201. The cloud server 160 shares the same architecture as that in the computer module 201. The memory 234 represents a logical aggregation of all the memory modules (including the HDD 210 and semiconductor memory 206) that can be accessed by the computer module 201 in FIG. 2A.

When the computer module 201 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high level functions, including processor management, memory management, device management, storage management, software application interface, and generic user interface.

The operating system 253 manages the memory 234 (209, 206) to ensure that each process or application running on the computer module 201 has sufficient memory in which to execute without colliding with memory allocated to another process. Furthermore, the different types of memory available in the system 200 of FIG. 2A must be used properly so that each process can run effectively. Accordingly, the aggregated memory 234 is not intended to illustrate how particular segments of memory are allocated (unless otherwise stated), but rather to provide a general view of the memory accessible by the computer system 200 and how such is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using the connection 218. The memory 234 is coupled to the bus 204 using the connection 219.

The application program 233 includes the sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from the storage medium 225 inserted into the corresponding reader 212, all depicted in FIG. 2A. The execution of a set of the instructions may in some cases result in output of data. Execution may also involve storing data or variables to the memory 234.

The described arrangements use input variables 254, which are stored in the memory 234 in corresponding memory locations 255, 256, 257. The arrangements described produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:
a fetch operation, which fetches or reads an instruction 231 from the memory locations 228, 229, 230;
a decode operation in which the control unit 239 determines which instruction has been fetched; and
an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to the memory location 232.

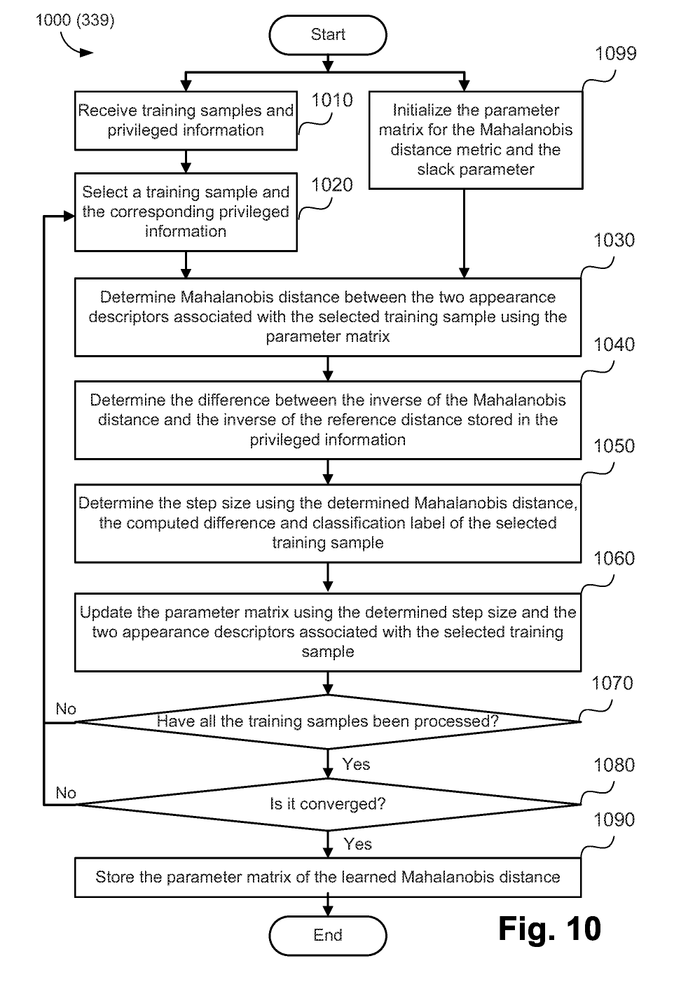

Each step or sub-process in the processes of FIGS. 3, 4, 5, 7, 8 and 9 is associated with one or more segments of the program 233 and is performed by the register section 244, 245, 247, the ALU 240, and the control unit 239 in the processor 205 working together to perform the fetch, decode, and execute cycles for every instruction in the instruction set for the noted segments of the program 233. In some arrangements, each step or sub-process in the processes of FIGS. 6 and 10 are similarly associated with one or more segments of the program 233. In other arrangements, each step or sub-process in the processes of FIGS. 6 and 10 are associated with one or more segments of a program stored on the cloud server 160.

The arrangements described may alternatively be implemented in dedicated hardware such as one or more integrated circuits performing the LCML functions or sub functions. Such dedicated hardware may include graphic processors, digital signal processors, or one or more microprocessors and associated memories, and may reside on platforms such as video cameras.

FIG. 3 shows a method 300 for matching objects between images using a locally constrained distance metric learning technique. In one example, the matching method 300 is used to determine the identity of an object in an image. The method 300 is typically implemented by one or more modules of the application 233, stored in the memory 206 and controlled under execution of the processor 205. In some arrangements, portions of the method 300 are executed on a processor of a cloud server computer, such as the cloud server 160.

The method 300 is described by way of example with reference to the image 120a containing the object of interest 131 detected at the bounding box 199, and the image 110a containing candidate objects 130, 131 and 132, detected at the bounding boxes 190, 191 and 192, as illustrated in FIG. 1B. In the example described, the goal of the method 300 is to determine which of the detections 190, 191 and 192 is the object of interest 131, detected at 199. The following description provides details, examples and alternative implementations for the main steps of the method 300. Further details, examples and alternative implementations of steps 319, 339, 330, 370, and 395 are described hereafter.

The method 300 starts at a creation step 319 Execution of the step 309 creates a training dataset containing several training samples and determines privileged information at a customer server. The method 300 progresses under execution of the processor 205 from the step 319 to transmitting step 329. The training samples and privileged information are transmitted from the customer server to the cloud service via internet at execution of the transmission step 329.

The method 300 progresses under execution of the processor 205 from the step 329 to a learning step 339. The learning step 339 uses the training samples and privileged information to learn a distance metric. The distance metric may be learned at the computer module 201 or, in some arrangements, at a cloud server such as the cloud server 160. The method 300 progresses under execution of the processor 205 from the step 339 to transmitting step 349. The parameters of the learned distance metric are transmitted from the cloud server 160 to the customer server at execution of the step 349 and is used to determine the distances between images at a step 380. The step 380 is described below. The steps 319, 329 and 339 effectively operate to perform a training sequence using a training set of images. The training sequence is implemented on the cloud server 160 in some arrangements.

The method 300 also starts at a receiving step 310. At execution of the step 310, at least one image containing a query object is received as input. For example, the image 120a is the query image containing the query object 131. The method 300 progresses under execution of the processor 205 from the step 310 to a determining step 320. The determining step 320 executes to determine a query object from the received query images. One example of determining the query object uses a pedestrian detection method to detect all persons in the query images. A commonly-used pedestrian detection method learns a detector to search for persons within an image by scanning pixel locations. The detector produces a high score if the local image features inside the local search window meet certain criteria. The local image feature may be the histogram of oriented gradients or local binary pattern. Other pedestrian detection methods include the part-based detection method and background subtraction method. The output of the pedestrian detection method is a set of bounding boxes. The image region defined by each bounding box contains a person. And another example of determining the query object uses a known car detection method, for example a trained classifier, to detect all cars in the query images.

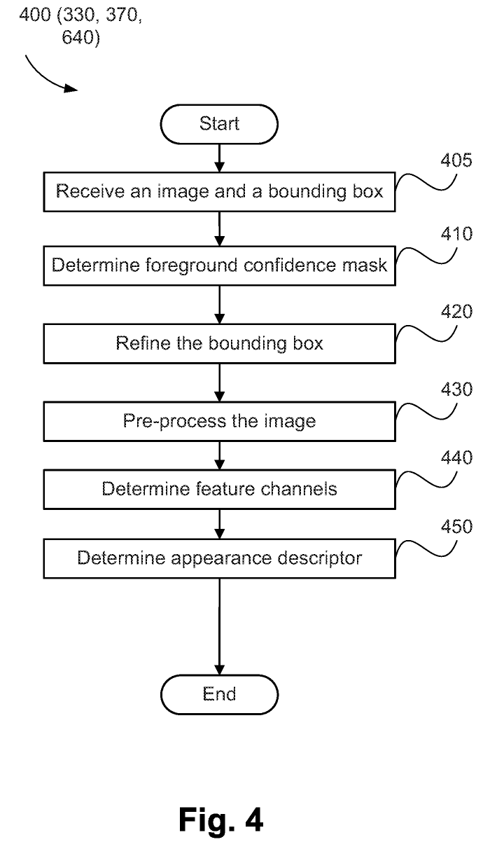

A user, e.g., a security guard, selects the image region defined by a bounding box as the query object via a graphical user interface executing on the system 200. In another example of determining the query object, the user may manually draw a bounding box containing an object and select the image region defined by the bounding box as the query object via a graphical user interface executing on the module 201. The output of the determining step 320 is the query image and the bounding box, e.g., the bounding box 199 in the image 120a shown in FIG. 1B. The method 300 progresses under execution of the processor 205 from the step 320 to a determining step 330. An appearance descriptor for the query object determined at execution of the step 320 is formed at execution of the step 330. Further details, examples and alternative implementations of the step 330 are described hereafter in relation to FIG. 4.

The method 300 also starts at a receiving step 340. In execution of the step 340, at least one image containing gallery objects is received as input, for example the image 110a from the camera 115. The steps 319, 310 and 340 can in some implementations start concurrently. However, in some arrangements, the steps 319, 310 and 340 start at different times. For example, step 319 typically starts before step 310, and step 310 may start before step 340.

The method 300 progresses under execution of the processor 205 from the step 340 to a determining step 350. A set of gallery objects is determined from the gallery images at the detecting step 350 using a pedestrian detection method in one example. The output of the pedestrian detection method is the gallery images and a set of bounding boxes. e.g., the bounding boxes 190, 191, and 192 in the image 110a shown in FIG. 1B(2). In another example, a set of gallery objects is determined from the gallery images at the detecting step 350 using a car detection method. The output of the car detection method is the gallery images and a set of bounding boxes. The image region defined by each bounding box is used as a gallery object.

The method 300 progresses under execution of the processor 205 from the step 350 to a selecting step 360. At the selecting step 360, an unprocessed gallery object is selected for comparing with the query object determined at step 320. In one arrangement, the gallery objects determined at detecting step 350 are stored in a list, for example in the memory 206, and the next unprocessed gallery object is selected by enumerating the objects in the list. The method 300 progresses under execution of the processor 205 from the step 360 to a determining step 370. The appearance descriptor for the selected gallery object is determined at the step 370.

The method 300 progresses under execution of the processor 205 from the step 370 to a determining step 380. The distance determining step 380 executes to determine the distance between the appearance descriptor of the selected gallery object and the appearance descriptor of the query object determined at step 330 using the distance metric parameterized by the parameter matrix received from the step 349.

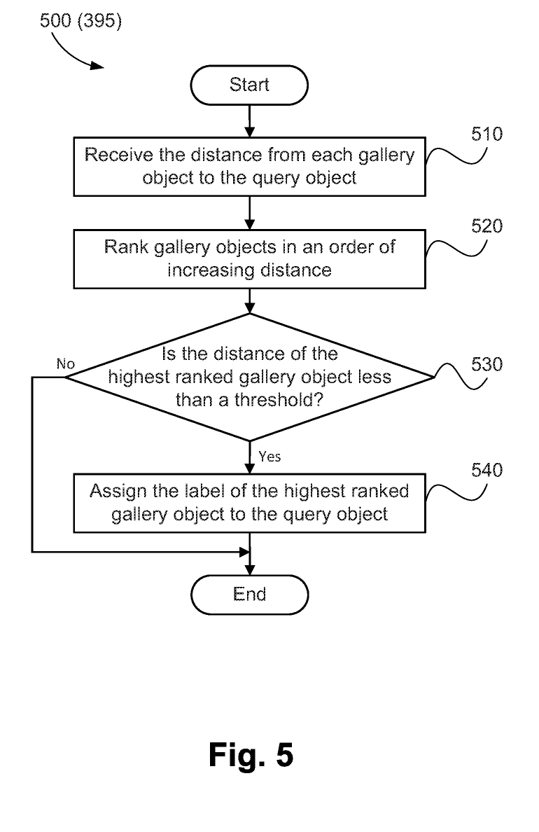

The method 300 then proceeds under execution of the processor 205 from the step 380 to a decision step 390. Execution of the step 390 determines whether every gallery object has been processed. If the distance between every gallery object and the query object has been determined (Yes at step 390), the method 300 proceeds from the step 390 to a matching step 395. If unprocessed gallery objects remain (No at step 390), the method 300 returns from the decision step 390 to the selecting step 360. A method 500 for matching the query object and gallery objects, applied at the step 395 is described with reference to FIG. 5. The step 395 operates to match at least one pair of images (the query object and the gallery object) based on the distance determined in the step 380. The method 300 concludes after completing the matching step 395.

A method 400 of determining an appearance descriptor of an object, as executed at the steps 330 and 370 of the method 300 is now described with reference to FIG. 4. The method 400 may be implemented within the computer system 200 as one or more software code modules of the software application program 233 resident in the hard disk drive 210 and controlled by execution of the processor 205.

The query images of steps 310, 320 and 330 and the gallery images of steps 340 to 380 are typically captured using different cameras and/or different camera settings. In some arrangements, for example if the training sequence is completed on the cloud server 160, one of the query images and the gallery images are captured using a remote camera such as the camera 116.

The method 400 starts at a receiving step 405. In execution of the receiving step 405, an image or image sequence containing the object and the corresponding bounding box produced by the determining step 320 or the determining step 350 is received as input. In one arrangement, the bounding box containing the whole body of a person is received. In one example, when the method 400 is applied to the query object 131 shown in FIG. 1B(1), step 405 receives the image 120a and the bounding box 199 as input. In another example, when method 400 is applied to the gallery objects 130, 131 and 132 shown in FIG. 1B(2), step 405 receives the image 110a and the bounding boxes 190, 191 and 192 as input. In another example, the bounding boxes containing head regions of persons are received.

The method 400 passes under execution of the processor from the step 405 to a determining step 410. Execution of the step 410 determines a foreground confidence mask. The foreground confidence mask assigns to each pixel in the bounding box received at step 405 a value indicating a confidence that the pixel belongs to an object. In one arrangement, a foreground confidence mask is determined by performing foreground separation using a statistical background pixel modelling method such as Mixture of Gaussian (MoG), wherein the background model is maintained over multiple frames with a static camera.

The method 400 passes under execution of the processor 205 from step 410 to a refining step 420. The step 420 executes to refine the bounding box received at step 405 to tightly bound the person's body, based on the foreground confidence mask determined at step 410. In one arrangement, the bounding box for the head region received at step 405 is converted to a full body bounding box by only including the pixels with a foreground confidence value determined at step 410 higher than a per-defined threshold and within a reasonable distance from the head region. In another arrangement, the bounding box for the whole body received at step 405 is refined (by shrinking or extending) to include the pixels with a foreground confidence value determined at the step 410 higher than a per-defined threshold and within a reasonable distance from the body region.

The method 400 passes under execution of the processor 205 from step 420 to a pre-processing step 430. In execution of the pre-processing step 430, the image region inside the bounding box determined at step 420 is pre-processed for feature computation. In one arrangement, a weighting scheme is used to weight every pixel of the image region inside the bounding box determined at step 420. One example of the weighting scheme uses a 2-D Gaussian function to weight the pixels based on the spatial locations. The pixels located close to the centre of the bounding box is assigned by higher weight than the pixels located further from the centre of the bounding box. Another example of the weighting scheme uses the foreground confidence mask determining step 410 to weight the pixels based on the distances from the pixel locations to the geometric mean of the foreground confidence mask. In another arrangement, the observed object in the bounding box determined at step 420 is rectified to a vertical orientation, which reduces a variation in the visual appearance of an object due to the viewpoint of the camera. In yet another arrangement, colour normalization is applied to the image inside the bounding box determined at step 420 to compensate lighting changes across cameras.

The method 400 passes under execution of the processor 205 from step 430 to a determining step 440. Execution of the step 400 determines feature channels for the pre-processed image generated in the step 430. At each feature channel, each pixel in the image is assigned a feature value. In one arrangement, a feature channel is the red channel of the image. In another arrangement, a feature channel is the green channel of the image. In yet another arrangement, a feature channel is the blue channel of the image. In still another arrangement, a feature channel is local binary patterns (LBP) of the image. In yet another arrangement, a feature channel is the image gradient of the image.

The method 400 passes under execution of the processor 205 from step 440 to a determining step 450. Execution of the step 450 determines the appearance descriptor from the feature channels determined at the step 450. The appearance descriptor, also referred to as a feature vector, is determined based on pixel properties of pixels in a region of an image. In one arrangement, the appearance descriptor is determined by concatenating pixel properties such as colour, texture and shape feature components, encoding a spatial distribution of colour and texture by dividing an image into regions. The colour feature component consists of colour histograms computed independently over numerous horizontal stripes, e.g., 15, from the colour feature channels determined at step 440. Histograms are normalized to a sum of unity for each stripe. The shape feature component is a histogram of oriented gradients (HOG) descriptor calculated based on the image gradient feature channel determined at step 440. The texture feature component consists of LBP histograms determined independently for cells with pre-defined size, based on the LBP feature channel determined at step 440. The appearance descriptor is formed by concatenating the square root of the above components to form a single vector. In another arrangement, the appearance descriptor is determined by encoding appearance as the difference between histograms across pairs of local regions. The method 400 concludes after completing the determining step 450. An appearance descriptor is typically in form of a vector and may also be referred to a plurality of feature vectors. The steps 410 to 450 effectively operate to determine feature vectors based on pixel properties of pixels in the received image or sequence of images.

The method 500 of matching a query object to a gallery object, as executed at step 395 of FIG. 3, is now described with reference to FIG. 5. The method 500 is typically implemented within the computer system 200 as one or more software code modules of the software application program 233 resident in the hard disk drive 210 and controlled in execution of the processor 205. The method 500 starts at a retrieving step 510. In execution of the step 510, the distance from each gallery object to the query object determined at step 380 is received as input.

The method 500 passes from step 510 to a ranking step 520. Execution of the step 520 ranks the gallery objects based on the distances from the gallery objects to the query object. The gallery objects are typically ranked in an order of increasing distance. The method 500 passes from step 520 to a decision step 530. Execution of the step 530 determines if the distance from the highest ranked gallery object to the query object is less than a pre-determined threshold. If the distance from the highest ranked gallery object to the query object is not less than the pre-determined threshold (No at step 530), the method 500 concludes. Otherwise, if the distance from the highest ranked gallery object to the query object is less than a pre-determined threshold (Yes at step 530), the method 500 proceeds under execution of the processor 205 from step 530 to a label assigning step 540. In execution of the step 540, the same identity label is assigned to both the highest ranked gallery object and the query object. The highest ranked gallery object is considered a match to the query object. The method 500 concludes after completing the step 540.

A method 600 of creating a training dataset and determining privileged information at a cloud server, as executed at the step 319, is now described with reference to FIG. 6. The method 600 is typically implemented as one or more software code modules of the software application program 233 resident in the hard disk drive 210 and being controlled in execution by the processor 205 both within the computer system 200. The method 600 may in some arrangements be executed at least in part on a processor of the cloud server 160.

The method 600 starts at an installing step 605. In execution of the installing step 605, a system is installed on the cloud server 160. The system is implemented as one or more software code modules of the software application program 233 resident in the hard disk drive 210 and being controlled in execution by the processor 205 within the computer system 200. In one LCML arrangement, the system enables the user to generate training samples within the computer module 201, and transmit data between the computer module 201 and the cloud server 160. The cloud server 160 may for example be operated by a customer using the arrangements described.

The method 600 passes under execution of the processor 205 from step 605 to a collecting step 610. In execution of the step 610, image sequences of a plurality of query objects and image sequences of a plurality of gallery objects are collected from cameras installed at the customer site as input. The method 600 passes under execution of the processor 205 from step 610 to a determining step 620. At the step 620, the identity labels indicating objects' identities are determined by matching query objects and gallery objects. In one arrangement, the query and gallery objects are matched manually through a graphical user interface. In one example, a security guard user determines the matches by watching the image sequences of both query objects and the gallery objects. The security guard assigns the same label to the query and gallery objects with the same identifier by manipulation of inputs of the computer module 201 or by communication with the cloud server 160. In another example, the security guard selects the query object by tagging the object, and the application 233 automatically returns a list of candidate objects from the gallery image sequences. The security guard only needs to select the true matches from the returned list to the system. The result from execution of step 620 is the identity labels assigned to the query objects and gallery objects.

The method 600 passes under execution of the processor 205 from step 620 to a creating step 630. In execution of the step 630, pairs of training images are created from the query objects and gallery objects based on the identity labels determined at the step 620. Each pair of training images contains a query object and a gallery object and the corresponding identity labels. A training image pair is called a positive image pair if both the query object and gallery object have the same identity label. Otherwise, a training image pair is called negative image pair. A positive image pair can be created by selecting a query object and a gallery object that has the same identity label as the query object. A negative image pair can be created by selecting a query object and randomly selecting a gallery object that has a different identity label from the query object.

The method 600 continues under execution of the processor 205 from the step 630 to a determining step 640. The appearance descriptors for each of the query and gallery objects associated with a training image pair are determined at step 640 using the method 400 described in relation to FIG. 4. For example, a plurality of feature vectors are determined for a first image sequence of the training images and a plurality of feature vectors is determined for a second image sequence of the training images.

The method 600 passes under execution of the processor 205 from step 640 to a creating step 650. In execution of the step 650, pairs of training samples are created from the appearance descriptors determined from positive and negative image pairs. Each training sample contains appearance descriptors extracted from a query object and a gallery object and a classification label. The appearance descriptors extracted from a query object and a gallery object are called a query descriptor and a gallery descriptor, respectively. The classification label is +1 if the appearance descriptors associated with a training sample are extracted from a positive image pair, i.e., the query object and gallery object have the same identity label. Otherwise, the classification label is −1. A training sample is called a positive training sample if the classification label is +1. Otherwise, a training sample is called a negative training sample. The method 600 progresses under execution of the processor 205 from the step 650 to a determining step 660. The privileged information for each training sample is determined at step 660. The method 600 concludes after completing the determining step 660.

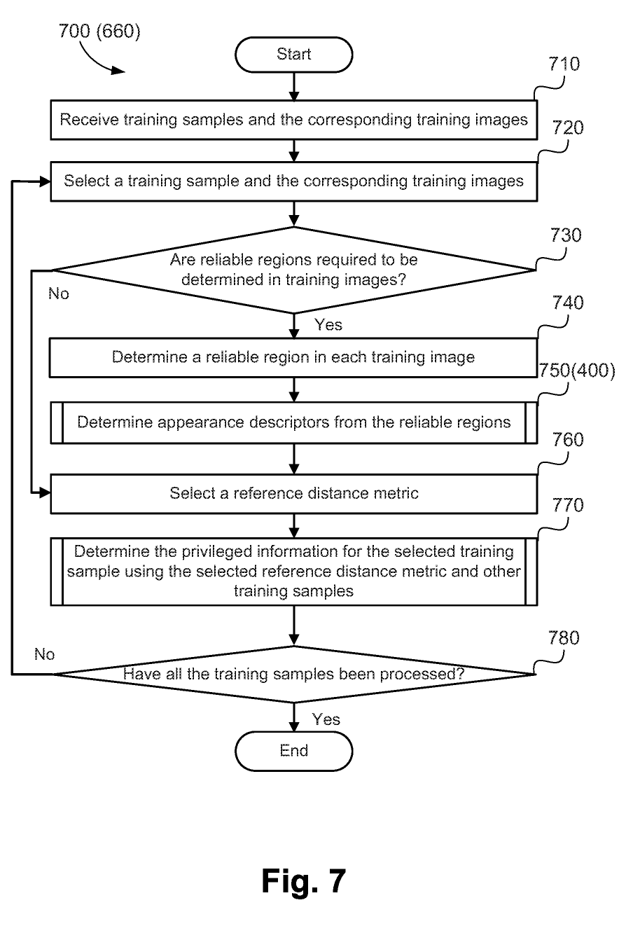

A method 700 of processing the training samples and determining privileged information for each training sample, as executed at step 660 of the method 600, is now described with reference to FIG. 7. The method 700 is typically implemented as one or more software code modules of the software application program 233 resident in the hard disk drive 210 and being controlled in execution by the processor 205 within the customer server 200.

The method 700 starts at a receiving step 710. In execution of the step 710, training samples determined at step 650 and training image pairs determined at step 630 in FIG. 6 are received as input. The method 700 continues under execution of the processor 205 to a selecting step 720. A training sample and the corresponding training image pair are selected at step 720. The method 700 passes under execution of the processor 205 from step 720 to a decision step 730. The application 233 executes to determine if a reliable region is required for determining the privileged information at step 730. A reliable region relates to a region whose visual appearance does not vary greatly with change of camera position and for which a bounding box may be clearly identified. An example of a reliable region of a person is determined as the torso and upper leg region of a person. Another example of a reliable region of a person is determined as the head region of a person. A reliable region is typically required for a person if the variation of person's pose is large, or if a person is partially occluded. If the object being matched is a car instead of a person the reliable region relates to a feature of the car such as a windscreen. A reliable region is typically required for a car if the car is partially occluded.

If a reliable region is not required for determining the privileged information (No at step 730), the method 700 proceeds under execution of the processor 205 from step 730 to a selecting step 760. Otherwise, if a reliable region is required for determining the privileged information (Yes at step 730), the method 700 proceeds from step 730 to a determining step 740.

At step 740, a reliable region is determined from each image of the training image pair. In one example, the reliable region is determined as the torso and upper leg region of a person. In one example, the reliable region is determined by creating a bounding box with a pre-defined size and position inside the full body bounding box received at step 710. In another example, the reliable region is manually determined by a user, e.g., a security guard. The user selects a suspicious object by drawing a rectangle around the reliable region on the object in the training image by manipulating inputs of the computer module 201. In yet another example, the reliable region is determined using a body part detection method such as a torso detector or an upper leg detector. If the object being matched is a car instead of a person the reliable region relates to a feature of the car such as a windscreen. In one example, the reliable region of a car is determined by creating a bounding box with a per-defined size and position inside the full body bounding box. In another example, the reliable region of a car is determined by a learned detector based on shape information.

The method 700 proceeds under execution of the processor 205 from the step 740 to a determining step 750. The appearance descriptor or feature for each reliable region determined at step 740 is determined at step 750 by using the method 400 described in relation to FIG. 4. Step 750 effectively operates to determine feature vectors for a region of an object of a first image sequence of the training images and feature vectors for a region of a second image sequence of the training images. The 700 proceeds under execution of the processor 205 from the step 750 to a selecting step 760. A reference distance metric is selected at the selecting step 760. In one example, a reference distance metric is selected as one of the general-purpose distance metrics, e.g., Euclidean distance, cosine distance, and Manhattan distance. In another example, a reference distance metric is selected as the inverse of a kernel function such as a Gaussian kernel or a Chi-squared kernel.

The 700 proceeds under execution of the processor 205 from the step 760 to a determining step 770. Based on the selected reference distance metric, the privileged information for the training sample is determined at execution of the step 770. The step 770 effectively operates to determine a reference distance used to determine privileged information. The reference distance relates to privileged information that represents a measure of correspondence between the training samples. The reference distance relates to a distance between a person in a first image sequence and a reference person in another image sequence of the training set. The reference distance can be determined in relation to a positive pair (the reference person is the same person as in the first image sequence), or a negative pair (the reference person is a different person).

The method 700 passes under execution of the processor 205 from step 770 to a decision step 780. The step 780 executes to determine if all the training samples have been processed. If all the training samples have not been processed (No at the step 780), the method 700 proceeds from step 780 to the selecting step 720. Otherwise, if all the training samples have been processed (Yes at step 780), the method 700 concludes after completing the decision step 780.

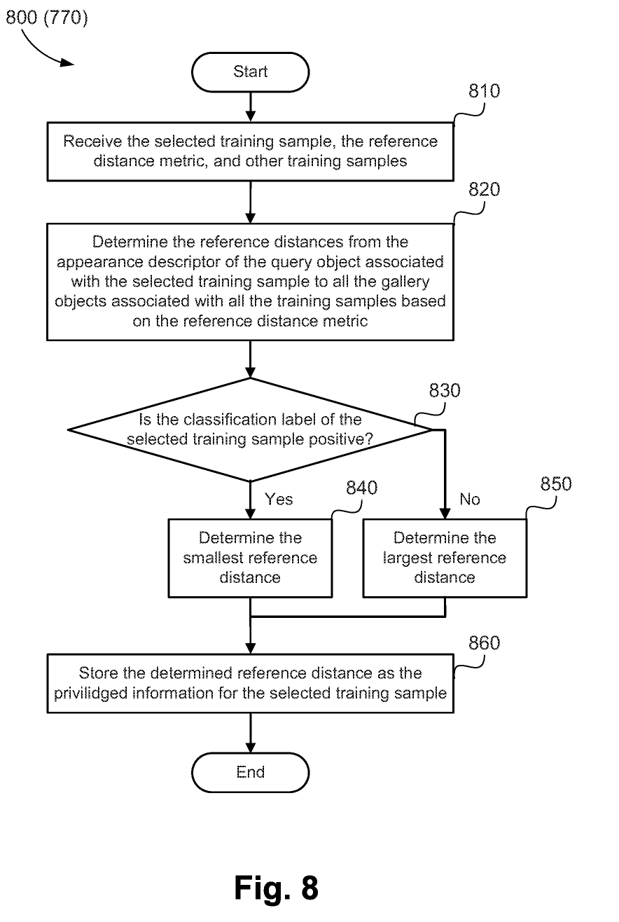

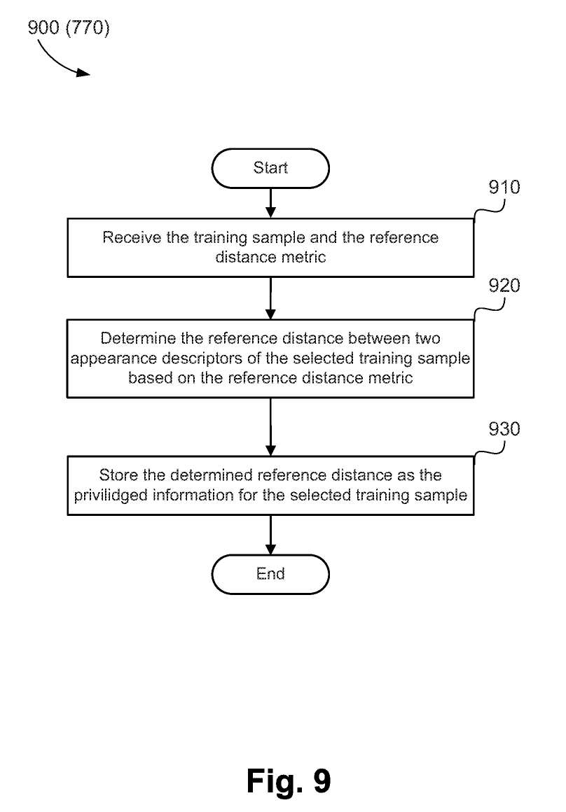

There are two alternate methods, 800 and 900 that can be used to determine the privileged information for a training sample using the selected reference distance metric, as executed at step 770 in FIG. 7. The methods 800 and 900 are described hereafter in relation to FIGS. 8 and 9 respectively. Each of the methods 800 and 900 is typically implemented as one or more modules of the application 233 stored in the memory 209 and executed under control of the processor 205.

The method 800 for determining the privileged information for a training sample using the selected reference distance metric is now described with reference to FIG. 8. The method 800 starts at a receiving step 810. In execution of the step 810, a training sample selected at step 720 or determined at step 750, the reference distance metric selected at step 760, and other training samples received at step 710 in FIG. 7 are received as input. Each training sample contains a query descriptor and a gallery descriptor.

The method 800 proceeds under execution of the processor 205 from the step 810 to a determining step 820. The reference distances from the query descriptor of the training sample (for example a first person) selected at step 720 to gallery descriptors associated with other training samples are determined at step 820 based on the selected reference distance metric. Each reference distance can be normalised after the reference distance determination. In one example, each reference distance is normalised by using a min-max normalisation method. In another example, each reference distance is normalised by the sum of all the reference distances.

The method 800 passes under execution of the processor 205 from step 820 to a decision step 830. The decision step 830 executes to determine if the classification label of the selected training sample is positive. If the classification label of the selected training sample is positive (Yes at the step 830), the method 800 proceeds from step 830 to the determining step 840. Execution of the step 840 determines the smallest reference distance from the distances determined at step 820. Otherwise, if the classification label of the selected training sample is not positive (No at the step 830), the method 800 proceeds from step 830 to a determining step 850. The determining step 850 determines the largest reference distance from the distances determined at step 820. The steps 820 to 850 effectively operate to determine distances between the query object and each of the gallery objects and determining a classification of the label associated with the query and gallery objects.

The method 800 proceeds under execution of the processor 205 from the steps 840 and 850 to a storing step 860. The distance determined at step 840 or step 850, also referred to as a reference distance, is stored as the privileged information for the selected training sample at step 860, for example on the hard drive 210. The method 800 concludes after completing the storing step 860.

The method 900 of determining the privileged information for a training sample using the selected reference distance metric is now described with reference to FIG. 9. The method 900 starts at a receiving step 910. In execution of the step 910, a training sample selected at step 720 or determined at step 750 and the reference distance metric selected at step 760 in FIG. 7 are received as input.

The method 900 proceeds under execution of the processor 205 from the step 910 to a determining step 920. The reference distance from the query descriptor to the gallery descriptor of the received training sample is determined at step 920 based on the reference distance metric. Each reference distance may be normalised after calculating the reference distances for all the training samples. In one example, each reference distance may be normalised by using a min-max normalisation method. In another example, each reference distance may be normalised by the sum of all the reference distances. The method 900 proceeds under execution of the processor 205 from the step 920 to a storing step 930. The distance determined at step 920, also referred to as a reference distance, is stored as the privileged information for the received training sample at step 930, for example on the hard drive 210. The method 900 concludes after completing the storing step 930.

A method 1000 of learning a distance metric using training samples and the privileged information transmitted by the cloud server 160, as implemented at step 339 of FIG. 3, is now described with reference to FIG. 10. The method 1000 is implemented by one or more modules of the application 233 stored on the hard drive 210 and controlled by execution of the processor 205. Alternatively, the method 1000 may be implemented on the cloud server 160.

The method 1000 learns a Mahalanobis distance metric d_{M}(xᵢ,yᵢ) described as

d_{M}(xᵢ,yᵢ)=(xᵢ−yᵢ)^{T}M(xᵢ−yᵢ) Equation (1)

where M represents the parameter matrix to be estimated, and xᵢ and yᵢ denote the query descriptor and gallery descriptor associated with a training sample, respectively. The parameter matrix M is a positive semi-definite matrix.

The method 1000 starts at a receiving step 1010. In execution of the receiving step 1010, all the training samples and privileged information determined at step 319 and transmitted from step 329 in FIG. 3 are received as input. The method 1000 also starts at an initialisation step 1099, wherein the parameter matrix M is initialised by a pre-defined matrix and the slack parameter y is initialised by a pre-defined value, e.g., y=1.0. The pre-defined matrix may be an identity matrix or may be determined based on prior knowledge of the feature space.

The method 1000 proceeds under execution of the processor 205 from the step 1010 to a selecting step 1020. A training sample and the corresponding privileged information are selected at the selecting step 1020. The method 1000 proceeds under execution of the processor 205 from the step 1020 to a determining step 1020. The Mahalanobis distance d_{M}(xᵢ,yᵢ) between the query descriptor xᵢ and gallery descriptor yᵢ associated with the selected training sample is determined based on the parameter matrix M at step 1030.

The method 900 passes from the determining step 1030 to a determining step 1040. In execution of the step 1040, the difference is determined between the inverse of the Mahalanobis distance d_{M} (xᵢ, yᵢ), determined at step 1030 and the inverse of the reference distance Dᵢ corresponding to the selected training sample, received at step 1010. In one LCML arrangement, the difference α is determined as

$$α = \frac{{l}_{i}}{2} ( \frac{1}{{d}_{M} ( {x}_{i} , {y}_{i} )} - \frac{γ}{{D}_{i}} ) \qquad Equation ( 2 )$$

where lᵢ represents the classification label of the training sample and γ represents the slack parameter.

The method 1000 proceeds under execution of the processor 205 from the step 1040 to a determining step 1020. A step size β is determined at step 1050 based on the Mahalanobis distance d_{M}(xᵢ,yᵢ) determined at step 1030, the difference α determined in step 1040, and the classification label lᵢ for the training sample. In one LCML arrangement, the step size β is determined as

β=lᵢα/(1−lᵢαd_{M}(xᵢ,yᵢ)) Equation (3)

The method 1000 passes from the determining step 1050 to an updating step 1060. In execution of the step 1060, the parameter matrix M of the Mahalanobis distance metric is updated based on the step size β determined at step 1050 and the query descriptor xᵢ and gallery descriptor yᵢ associated with the selected training sample. In one LCML arrangement, the parameter matrix M is updated as

M←M+βM(xᵢ−yᵢ)(xᵢ−yᵢ)^{T}M Equation (4)

Execution of the steps 1040 to 1060 effectively operates to constrain a distance between the appearance descriptor corresponding to the first person in the first image sequence and an appearance descriptor corresponding to the first person in the second image sequence according to the reference distance determined in step 770.

The method 1000 passes from the updating step 1060 to a decision step 1070. The decision step 1070 determines if all the training samples have been processed. If all the training samples have been processed (Yes at step 1070), the method 1000 proceeds from the step 1070 to a convergence decision step 1080. If there exist any training sample to be processed (No at step 1070), the method 1000 returns from the decision step 1070 to the selecting step 1020. The convergence decision step 1080 executes to determine if the method 1000 converges. In one LCML arrangement, the convergence is measured by the change in the parameter matrix M after being updated at step 1060. In one example, the change in the parameter matrix M is measured by the L−1 norm of the difference between the matrix after being updated and that before being updated. If the change is larger than a pre-defined threshold, for example, 0.001, convergence is not found (No at step 1080) and the method 1000 returns from the decision step 1080 to the selecting step 1020. If the change is smaller than the pre-defined threshold, convergence is found (Yes at step 1080) and the method 1000 proceeds from step 1080 to a storing step 1090. In execution of the step 1090, the learned parameter matrix for the Mahalanobis distance metric is stored, for example in the memory 206, for transmission to the customer server at step 349. The learner parameter matrix forms a distance metric for use in matching objects such as persons in captured images, as used at step 380 of FIG. 3. The method 1000 concludes after completing the storing step 1090.

The arrangements described are applicable to the computer and data processing industries and particularly for image processing industries such as surveillance or safety industries. The arrangements described provide methods by which face images captured by cameras such as surveillance cameras can be matched. The arrangements described are particularly useful in the security industry. For example, an incident may have occurred in the vicinity of the scene of the captured image 110a of FIG. 1B(1) shortly after time of capture of the image 110a. Persons in the area of the incident near that time may be of interest to security forces. If the face of the query image 199 of FIG. 1B(2) is found to match the face of the database image 191 of FIG. 1B(1), security forces may require details regarding the match.

In one example, a security guard selects images using the computer module 201 and provides a corresponding training set including first and second images to the cloud server 160. The cloud server 160 executes a training sequence (steps 319 to 349) to determine a distance metric at step 339. The server 160 transmits the distance metric to the computer module 201 which executes the application 233 to match persons in the images 110a and 120a using the distance metric.

The arrangements described use privileged information extracted from the visual appearance of objects to improve the distance metric learning which can provide an improved distance metric for image matching. The arrangements described do not rely on the privileged information extracted using different sensor modalities, thereby reducing complexity of distance metric determination. Use of reliable regions can provide a further improved distance metric for image matching.

The foregoing describes only some embodiments of the present invention, and modifications and/or changes can be made thereto without departing from the scope and spirit of the invention, the embodiments being illustrative and not restrictive.

The foregoing describes only some embodiments of the present invention, and modifications and/or changes can be made thereto without departing from the scope and spirit of the invention, the embodiments being illustrative and not restrictive.

1. A method of matching a person in a plurality of captured images, the method comprising:
determining a plurality of first feature vectors from a first image sequence of one or more persons, the first feature vectors being determined based on pixel properties of pixels located in the first image sequence;
determining a plurality of second feature vectors from a second image sequence of one or more persons, the second feature vectors being determined based on pixel properties of pixels located in the second image sequences;
for one of the first feature vectors corresponding to a first person in the first image sequence, determining a reference distance to one of the second feature vectors corresponding to a reference person in the second image sequence;
determining a distance metric by constraining a distance between the first feature vector corresponding to the first person in the first image sequence and a feature vector corresponding to the first person in the second image sequence, according to the determined reference distance; and
matching at least one pair of images of the person in the plurality of captured images based on a distance determined using the distance metric.

2. The method according to claim 1, wherein the reference person is the first person.

3. The method according to claim 1, wherein the reference person is a different person to the first person.

4. The method according to claim 1, wherein determining the reference distance comprises determining distances between the first person and each of the plurality of second vector features and determining a classification of a label associated with the first person and the reference person.

5. The method according to claim 4, wherein the label is a positive label and the reference distance relates to a minimum of the determined distances.

6. The method according to claim 4, wherein the label is a negative label and the reference distance relates to a maximum of the determined distances.

7. The method according to claim 1, wherein the reference distance between the first person and the reference person is determined based on a reference distance metric.

8. The method according to claim 1, wherein the reference distance is determined in relation to a reliable region of the first person and a reliable region of the reference person.

9. The method according to claim 1, wherein determining the distance metric comprises determining a difference between an inverse of the reference distance and the inverse of the distance between the first feature vector corresponding to the first person in the first image sequence and the feature vector corresponding to the first person in the second image sequence.

10. The method according to claim 1, wherein constraining the distance between the first feature vector corresponding to the first person in the first image sequence and the feature vector corresponding to the first person in the second image sequence comprises determining a step size between the reference distance and the distance between first feature vector corresponding to the first person in the first image sequence and the feature vector corresponding to the first person in the second image sequence.

11. The method according to claim 1, wherein the plurality of captured images comprise a query image and a gallery image, and the method further comprises:
determining feature vectors for a person in the query image and for a person in the gallery image;
and matching the at least one pair of images comprises determining a distance between the person in the query image and the person in the gallery image using the distance metric.

12. The method according to claim 1, wherein the first image sequence and the second image sequence form part of a training set of images.

13. The method according to claim 1, wherein the distance metric is determined on a server computer and the at least one pair of images of the person in the plurality of captured images is matched on a user computer in communication with the server computer.

14. The method according to claim 1, wherein determining the reference distance comprises determining reference distances between the first person and each of the plurality of second vector features and selecting one of the reference distances.

15. A computer readable medium having a program stored thereon for matching a person in a plurality of captured images, the program comprising:
code for determining a plurality of first feature vectors from a first image sequence of one or more persons, the first feature vectors being determined based on pixel properties of pixels located in the first image sequence;
code for determining a plurality of second feature vectors from a second image sequence of one or more persons, the second feature vectors being determined based on pixel properties of pixels located in the second image sequences;
code for, for one of the first feature vectors corresponding to a first person in the first image sequence, determining a reference distance to one of the second feature vectors corresponding to a reference person in the second image sequence;
code for determining a distance metric by constraining a distance between the first feature vector corresponding to the first person in the first image sequence and a feature vector corresponding to the first person in the second image sequence, according to the determined reference distance; and
code for matching at least one pair of images of the person in the plurality of captured images.

16. Apparatus for matching a person in a plurality of captured images, the apparatus comprising:
means for determining a plurality of first feature vectors from a first image sequence of one or more persons, the first feature vectors being determined based on pixel properties of pixels located in the first image sequence;
means for determining a plurality of second feature vectors from a second image sequence of one or more persons, the second feature vectors being determined based on pixel properties of pixels located in the second image sequences;
for one of the first feature vectors corresponding to a first person in the first image sequence, means for determining a reference distance to one of the second feature vectors corresponding to a reference person in the second image sequence;
means for determining a distance metric by constraining a distance between the first feature vector corresponding to the first person in the first image sequence and a feature vector corresponding to the first person in the second image sequence, according to the determined reference distance; and
means for matching at least one pair of images of the person in the plurality of captured images based on a distance determined using the distance metric.

17. A system, comprising:
a server computer;
a communications network and
a user device in communication with server computer via the communications network; wherein
the server computer comprises:
a memory for storing data and a computer readable medium; and
a processor coupled to the memory for executing a computer program, the program having instructions for:
determining a plurality of first feature vectors from a first image sequence of one or more persons, the first feature vectors being determined based on pixel properties of pixels located in the first image sequence;
determining a plurality of second feature vectors from a second image sequence of one or more persons, the second feature vectors being determined based on pixel properties of pixels located in the second image sequences;
for one of the first feature vectors corresponding to a first person in the first image sequence, determining a reference distance to one of the second feature vectors corresponding to a reference person in the second image sequence;
determining a distance metric by constraining a distance between the first feature vector corresponding to the first person in the first image sequence and a feature vector corresponding to the first person in the second image sequence, according to the determined reference distance; and
transmitting the distance metric to the user device via the network; and
the user device is configured to receive the distance metric via the communications network and execute a program to match at least one pair of images of a person in a plurality of captured images based on a distance determined using the distance metric.
